(19) United States
(12) Patent Application Publication
(10) Pub. No.: US 2003/0051173 A1
(43) Pub. Date: Mar. 13, 2003

(54) Computer security system

(76) Inventor: Steven J. Krueger, Olympia, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/953,588

(22) Filed: Sep. 10, 2001

(51) Int. Cl. H04L 9/32

(52) U.S. Cl. 713/202

(57) ABSTRACT

A computer access system utilizes an authentication gateway through which a user accesses a computer. Requests to access the computer are passed through the authentication gateway and the authentication gateway provides a code, such as a log-in name and password, to the computer. The log-in name and password are preferably unknown to the user such that access to the computer can only be achieved through the authentication gateway. In one embodiment of the invention, the user accesses the authentication gateway with a log-in name, password, and a biometric sample. Association of a biometric sample with a particular user is made through the use of an identification validation source that confirms the identification of an individual user.

### FIELD OF THE INVENTION

The present invention relates to computer systems and, in particular, to systems for verifying the identity of computer users.

### BACKGROUND OF THE INVENTION

At the present time, the most common methodology for limiting access to computer systems is through the use of a log-in name and associated password. This technique has been carried over to computers that are accessible on wide area networks such as the Internet. When a user's browser program requests a Web page that contains sensitive information or information that is available only to paying subscribers, a Web server prompts the user for a log-in name and password.

In many instances, the user's browser program will store the log-in name and password as a “cookie” on its internal hard drive. The next time the user accesses the Web site, the Web server computer will ask the user's computer if it has a cookie for it. If so, the user's computer will automatically transmit the cookie file, including the user's log-in name and password without the user having to retype it.

While this access methodology works well for some computer systems, there are several problems with this approach. First, because the log-in name and password are stored directly on a user's computer, there is always the possibility that an unauthorized user may be operating the computer such that they can access Internet sites or other computers without the proper user's permission. Secondly, even if a user's log-in name and password are not stored as a cookie, such information may become available through inadvertent disclosure, such that an unauthorized user can enter the information manually from a remote computer. Finally, even if a user enters his or her own log-in identification and password, the accessed computer has no guarantee that the user is legitimate.

As privacy rules and other standards for preventing the unauthorized disclosure of personal information become more common, there is a need for a computer system that can better limit access to authorized users only and certify the identification of those that do access a computer.

### SUMMARY OF THE INVENTION

A computer access system according to the present invention includes an authentication gateway that validates the identity of a user who accesses the computer through the authentication gateway. The user's identification is preferably validated by the authentication gateway using a biometric sample. The computer therefore utilizes the increased security associated with biometric validation but doesn't have to have the built-in capacity to implement biometric validation.

In one embodiment of the invention, the authentication gateway validates the identity of a user with a log-in name/password or other access codes. The access codes required to access the authentication gateway are associated with a particular user after the user's identity has been validated by an identification validation source, such as a bank. In addition, the authentication gateway can receive a biometric sample that is compared to a biometric sample known to come from a particular user.

In accordance with another embodiment of the invention, the authentication gateway provides one or more codes, such as a log-in name/password, to the computer being accessed through the authentication gateway to validate the identity of the user for the computer. Preferably, the one or more codes provided by the authentication gateway are unknown to the user.

In accordance with another embodiment of the present invention, the computer accessed through the authentication gateway stores codes for performing a function, such as unlocking a door, etc. The codes are transmitted to the user after the user's indentity has been confirmed by the authentication gateway.

In accordance with another embodiment of the invention, the authentication gateway stores, or allows access to another computer that stores, keys for unlocking programs or stored digital content. The keys are provided to the user after after the user's indentity has been confirmed by the authentication gateway.

In accordance with yet another embodiment of the invention, the authentication gateway allows access to a computer that facilitates financial transactions. The computer may perform a financial transaction after the user's identification has been confirmed by the authentication gateway.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a computer access system in accordance with one embodiment of the present invention;

FIG. 2 illustrates a computer access system in accordance with another embodiment of the present invention;

FIG. 3 illustrates a computer access system for downloading programs or content in accordance with another embodiment of the present invention; and

FIG. 4 illustrates a computer access system for facilitating electronic transactions in accordance with yet another aspect of the present invention.

### DETAILED DESCRIPTION OF THE PREFERRED EMBODIMENT

As indicated above, the present invention is a computer access system that limits access to authorized users and confirms the identity of users who access a computer system.

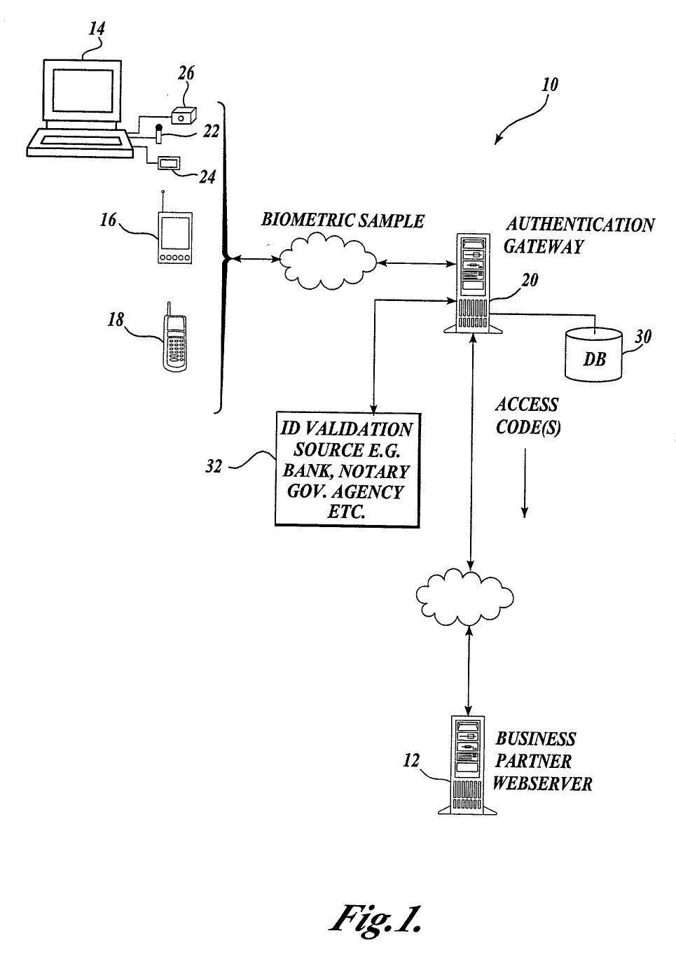

A block diagram of one embodiment of a computer access system 10 in accordance with the present invention is shown in FIG. 1. Using the system 10, a user accesses a remotely located computer 12 from a computer system 14, personal digital assistant (PDA) 16, networked cellular telephone 18, or other device for accessing a computer network. Communications between the user and the remotely located computer system 12 pass through an authentication gateway 20 that confirms the identity of the users who access the remotely-located computer 12.

To confirm the identity of a user, the user accesses the authentication gateway 20 with one or more access codes, such as a log-in name and a password, and by providing a biometric sample. The biometric sample provided could be a voice sample, a photograph, fingerprint, retinal scan, or any other sample that uniquely identifies the user. To provide the sample, the user's access device includes one or more sensors such as a microphone 22 for recording voice samples, a fingerprint scanner 24 for recording fingerprints, a digital camera 26 for recording images, or other sensor for detecting a biometric sample that can be converted to a digital form and transmitted via a wired or wireless link to the authentication gateway 20. The one or more access codes, such as the log-in name, password, and biometric sample, are compared with previously stored code data, as well as a stored biometric sample, that forms a standard against which the new biometric sample is compared. The standard biometric sample, log-in name, and password for each user are preferably stored in a database 30 or computer retrievable media that is associated with the authentication gateway 20. If the user accesses the authentication gateway 20 with a PDA 16 or cellular telephone 18, these devices must be similarly equipped with appropriate biometric sensors, i.e., cameras, microphones, etc., to record the sample. In some embodiments, the authentication gateway 20 may be accessed by a user by only providing a biometric sample. For example, the user could speak his or her name into a microphone and the recorded name would save as both the biometric sample and an access code.

To associate a biometric sample with a particular individual, the authentication gateway utilizes the identification-checking services of an identification validation source 32. In one embodiment of the invention, the identification validation source 32 is a bank. The user is asked by the authentication gateway to enter a bank account number. The authentication gateway 20 receives the account number and makes a small variable or random deposit (e.g., between 0.01 and 0.99 dollars) into the user's account. The user is then asked to report back to the authentication gateway how much money was deposited. If the user gets the amount correct, then the authentication gateway assumes that the user's identity has been confirmed because banks often require the presentation of a birth certificate or similarly reliable identification in order to set up an account. If the user does not have an account, they are asked to establish one and to provide authentication gateway with the account number when the account is established. Therefore, by relying on the identity verification procedures utilized by the bank, the authentication gateway confirms the identity of a user with a greater degree of confidence.

Although the present embodiment of the invention utilizes a bank as the identification validation source 32, it will be appreciated that other agencies or individuals, such as a notary public, governmental agency, or other identification validation service could be used to establish a person's identity to the satisfaction of the authentication gateway. Once the individual or agency has confirmed the identity of the user, the authentication gateway associates a biometric sample, log-in name, and password with the particular individual. The next time the user accesses the authentication gateway, he or she provides the log-in name, password, and another biometric sample that is compared to the data stored on the database 30. If the data matches or correlates, then the user can access the remotely located computer 12 via the authentication gateway. To limit access to the computer 12, the computer 12 may be programmed so that it only accepts entries or log-ins that access the computer through the authentication gateway 20.

In some environments, it may be desirable to have the authentication gateway enroll or register the user with the computer. For example, once the user accesses the gateway 20, the gateway fills out an enrollment form with the user's name and provides it to the remote computer 12. In some instances, it may be desirable to not allow the user to edit/alter the enrollment form. For example, in on-line voting systems, the authentication gateway can register the user after his or her identity has been confirmed. If the user could alter the registration form, the user could register under an alias, which, for voting or other applications, would be undesirable.

To further limit access to the remotely located computer 12, the computer 12 may utilize additional security methods, such as requiring its own access code(s), such as a log-in name and password. That is, when a user accesses the computer 12, a request for a Web page is provided from the user's access device to the authentication gateway 20. The authentication gateway 20 then forwards the request to the remotely located computer 12. The computer 12 responds with a request for an access code, such as a log-in name and password, from the authentication gateway 20. Preferably, the log-in name and password for a particular user are stored in a file that is associated with the user. However, the actual log-in name and password required to access the computer 12 should be unknown to the user and not transmitted to or accessible by the user's access device. Therefore, the user cannot access the computer system 12 in any way but through the authentication gateway.

If the computer system 12 utilizes cookie technology, the computer system 12 asks the authentication gateway 20 for a cookie that contains the access code(s), such as the log-in name and password, for the user. If available, the log-in and password are provided. If not, an indication that the information is not available is returned to the computer system 12 at which time the computer system 12 can generate a Web page with a request that such information be provided by the operator.

When accessed via the authentication gateway 20, the remote computer system 12 and the authentication gateway 20 preferably agree on a protocol for identifying users whose identification has been established. For example, the log-in identification may contain a unique identifier that indicates the user has accessed the computer system 12 through the authentication gateway 20. For example, all users that access the computer system 12 through the authentication gateway 20 may have a log-in name comprising a specific numeric code coupled with an alphanumeric identifier. A log-in name for a user John Doe may comprise the log-in identification 123456DOEJ, etc. If the computer 12 detects the specific identifier, then the computer 12 knows that the user is accessing via the authentication gateway 20 and that the authentication gateway has confirmed the identity of the user.

Once the user has accessed the authentication gateway 20, communications between the user and the computer system 12 pass through the authentication gateway 20 until the user logs off the authentication gateway.

As will be appreciated, one advantage of the present invention is that the computer 12 can still use its log-in/password security method, but has a greater degree of confidence in the identity of a user who accesses the computer 12 via the authentication gateway because the authentication gateway has either confirmed the identity of the user using the identification validation source 32 and/or confirmed the biometric sample that is provided by the user. Thus, the access code(s) provided to the computer 12 can be said to be biometrically validated without requiring the computer 12 to have the equipment/hardware and software to validate biometric samples.

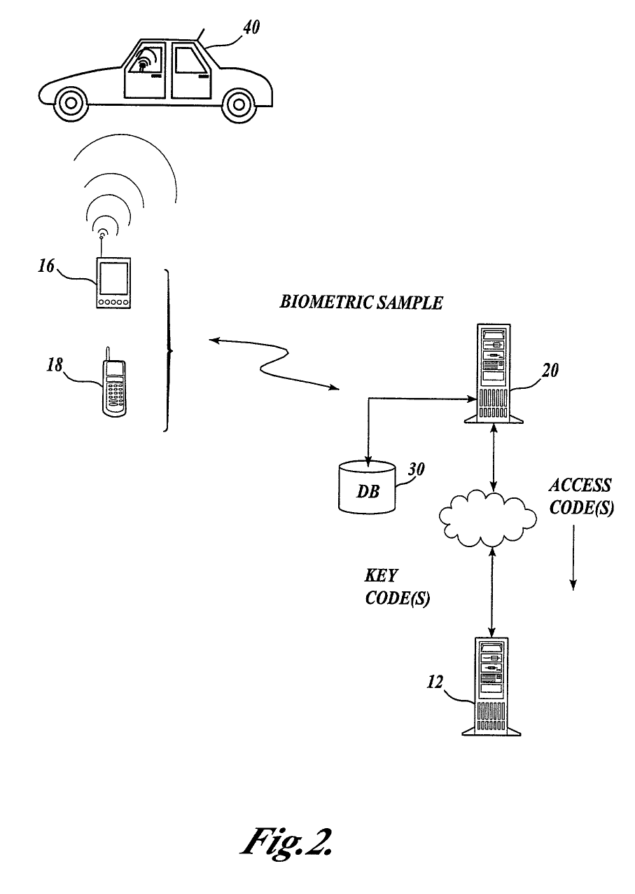

In another embodiment of the invention, the user may wish to access a security service that stores combinations or key codes to perform some function such as unlocking doors to a car 40, gaining entrances to buildings, etc. If such codes were stored directly on an electronic device, such as a PDA 16 or cellular phone 18, then such codes could be used by unauthorized users if the PDA 16 or cellular phone 18 were stolen. As shown in FIG. 2, to protect the security/key codes, the codes are stored on a remote computer system 12 that is accessed through the authentication gateway 20.

The user accesses the authentication gateway 20 by providing a log-in identification, password, and a biometric sample. This information is compared to previously validated information that is stored on the authentication gateway's database 30. Once the user has logged on to the authentication gateway 20, they can access the remote computer 12 to request a security/key code. Upon the request of a code, the computer system 12 asks the authentication gateway 20 for a log-in name and password for the user that are preferably stored as a cookie file. Again, the specific log-in name and password associated with a particular user are unknown to the user such that the user cannot access the remote computer system 12 except through the authentication gateway 20. In this manner, the computer system 12 has a high degree of confidence that the user's identity is legitimate. Upon successful log-in to the remote computer 12, the security/key code is returned to the user's access device (cell phone, PDA, etc.) such that the user can direct the received security/key code at the car 40 or electronic doorway, etc., in order to perform the desired task of opening the car/office door, etc.

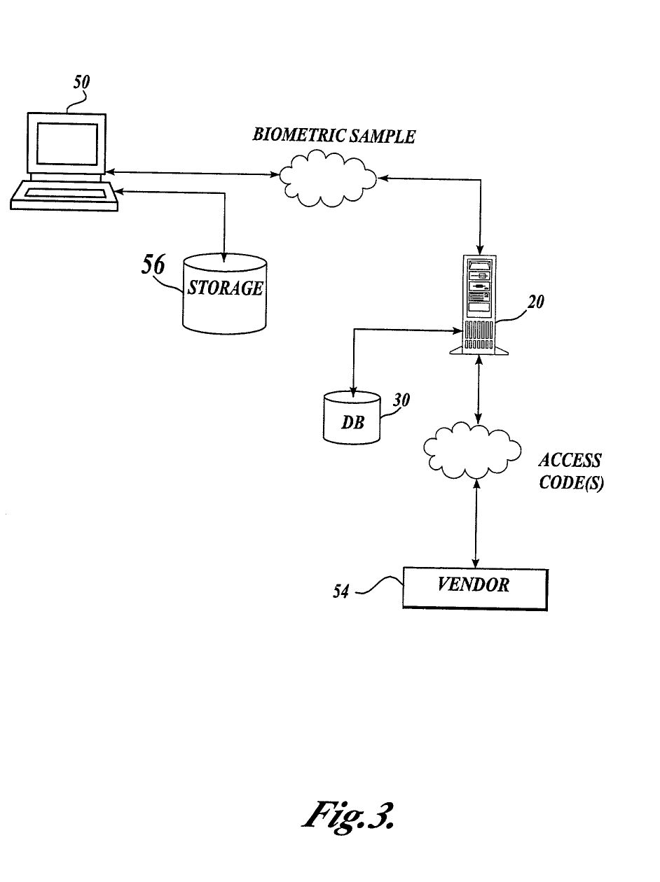

As shown in FIG. 3, the present invention also has utility with respect to storing access codes for registered computer programs or digital content. In this embodiment of the invention, a user accesses the authentication gateway 20 via his or her computer system 50 or other network-accessing device. Once the user has logged on to the authentication gateway 20 using his or her log-in name, password, and biometric sample, the identity of the user is validated by comparing the received information and biometric sample with the previously validated information stored on the database 30.

Once the user has logged onto the authentication gateway, he or she can connect to a computer system 54 from which a vendor sells or registers computer programs or digital content, such as text, music, artwork, video, etc. In order to limit access of the purchased material to a particular user, the vendor provides the digital material in an encrypted fashion along with a key that will allow the user to use, view, hear, etc., the downloaded program content. The program content is stored in its encrypted form on a storage media. Stored with the program or content is an instruction that will cause the computer system 50 to request a decrypting key that will unlock the program or digital content.

Before the program or the stored digital content can be used or accessed, the user must successfully log on to the authentication gateway 20 with the user's one or more access codes, such as a log-in name, password, and biometric sample. Upon successful access to the authentication gateway 20, the registered program or digital content makes a request for the unlocking key to be returned to the computer system 50. If the key is available, it is transferred to the computer 50 or network access device to unlock the program or digital content for the user to view/use. The next time the user wants to use the program/digital content, the program/digital content will make another request for the key from the authentication gateway 20. This embodiment of the invention has the advantage that the vendor or registrar of the program or content does not have to administer the keeping of security keys but can rely on the authentication gateway to ensure that all users of the program/digital content are legitimate.

The security keys do not have to be stored on the authentication gateway but could be stored on any computer that is accessible through the authentication gateway.

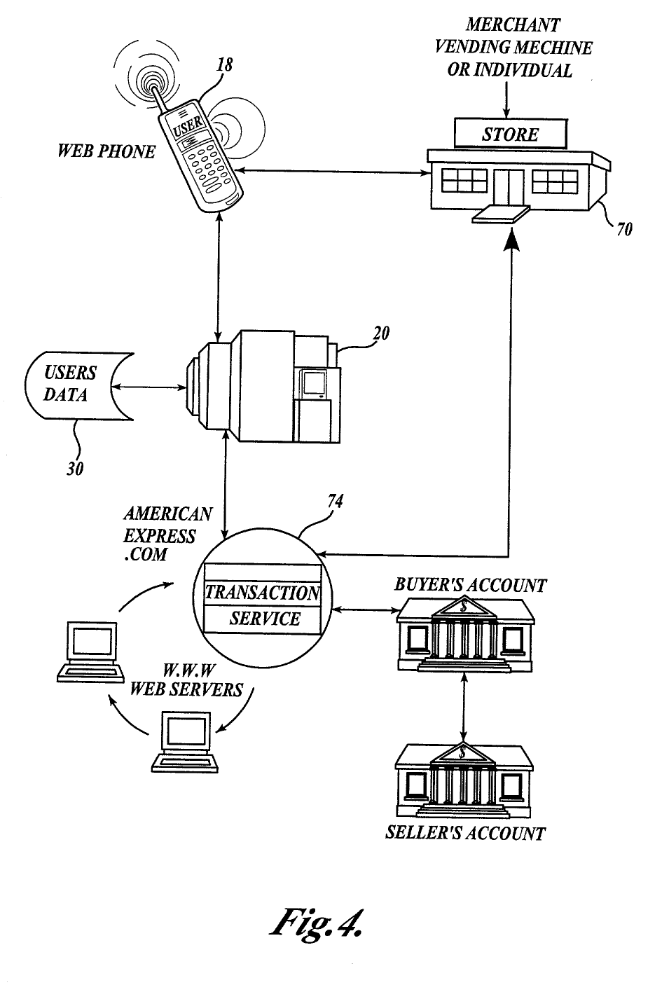

FIG. 4 illustrates yet another embodiment of the present invention. In this embodiment, the authentication gateway 20 facilitates financial transactions between a buyer and seller. A user accesses the authentication gateway 20 by an Internet-enabled cell phone 18 or other portable network access device. The user accesses the authentication gateway 20 by providing a log-in name, password, and preferably a biometric sample that are compared with previously validated data that are stored on the gateway's associated database 30. The user then interacts with a merchant at a shop or vending machine 70 and selects one or more items for purchase. The user then uses the access device 18 to request that the merchant provide an electronic bill that includes the merchant's bank account number. The access device 18 then accesses a transaction service 74 through the authentication gateway 20 to forward the bill to a transaction service 74. Upon receipt of the bill, the transaction service 74 operates to transfer money from the buyer's account to the seller's account.

When the user accesses the transaction service 74, the transaction service asks for a security code, such as a log-in name and password, from the authentication gateway 20. The log-in name and password are preferably included in a cookie whose contents are unknown to the buyer. Because the authentication gateway has confirmed the identity of the user, the transaction service 74 has a high degree of confidence that the user is legitimate and can transfer money between the buyer's account and the seller's account. In addition, the transaction service 74 can notify the merchant 70 that the transaction has been completed and provide an electronic record of the transaction.

As can be seen from the above, the present invention is a system for verifying the identity of users who access remote computer systems through the use of a biometric sample and the identification confirmation procedures provided by others to ensure that a user is legitimate. Although the present invention utilizes biometric samples in order to ensure the identity of a user, it would be appreciated that such samples could be omitted if desired. Therefore, the authentication gateway may simply use an indication from a third party that a user's identification has been checked and the user is legitimate. The user could then access the authentication gateway with one or more codes, such as a log-in name and password.

Furthermore, the present invention is not limited to the use of log-in names and passwords. For example, in closed systems, a token or random string of letters/characters/numbers could be used as a means for gaining access or privileges. An automated enrollment form may be returned to the user in the form of a cookie and a single security code, rather than a cookie file containing the user's log-in name and password to be used to gain entry or privileges. Furthermore, the present invention is not limited to cookie technology. For example, it is possible for the authentication gateway to deliver the user's blind log-in information directly to the Web site and bypass cookie technology. Finally, the present invention is not limited to computer systems that are accessible as Web sites. Any computerized secured resource using some form of security code as a means for gaining access could be modified to benefit from the present invention.

While the preferred embodiment of the invention has been illustrated and described, it will be appreciated that various changes can be made therein without departing from the scope of the invention. The scope of the invention is therefore to be determined from the following claims and equivalents thereto.

The embodiments of the invention in which an exclusive property or privilege is claimed are defined as follows:

1. A system for limiting access to a computer, comprising:
an authentication gateway through which a user accesses the computer, the authentication gateway receiving one or more access codes from the user and a biometric sample to authenticate the identity of the user,
the authentication gateway providing one or more authenticated access codes to the computer such that the user can access the computer.

2. A system for providing one or more access codes that validate the identity of a user to a computer system, comprising:
an authentication gateway through which the user accesses the computer system, the authentication gateway being programmed to:
(a) receive a biometric sample from the user;
(b) compare the biometric sample received with a reference sample known to come from the user;
(c) confirm the identify of the user based on the comparison of the biometric sample received with the reference sample; and
(d) upon confirmation of the identity of the user, transmit to the computer one or more codes required to access the computer, wherein said one or more access codes are unknown to the user.

3. The system of claim 2, wherein the reference biometric sample is associated with the user after confirmation of the user's identity by a third party.

4. The system of claim 3, wherein the third party is a bank.

5. The system of claim 2, wherein the one or more access codes include a log-in name and a password.

6. The system of claim 2, wherein the one or more access codes include a random string of characters or numbers.

7. The system of claim 2, wherein the one or more access codes are stored in a cookie file at the authentication gateway.

8. A method for restricting access to a remote computer, comprising the acts of:
directing requests to connect a user to the computer to a gateway computer;
verifying the identity of a user at the gateway computer; and
allowing the user to access the computer once the user's identity has been verified by providing the computer with one or more access codes that are unknown to the user.

9. The method of claim 8, wherein the act of verifying the identity of a user includes the acts of:
receiving a biometric sample from the user; and
comparing the biometric sample with a stored sample that has been confirmed as originating with the user.

10. The method of claim 8, wherein the one or more access codes include a log-in name and password.

11. The method of claim 8, wherein the one or more access codes can be recognized by the accessed computer as coming from the gateway computer.

12. The method of claim 8, wherein the one or more access codes are stored as a cookie file in the gateway computer.

13. A method of connecting a user to a computer, comprising the acts of:
allowing a user to connect to an authentication gateway by:
a) providing a biometric sample;
b) comparing the biometric sample with a previously stored biometric sample that is associated with the user after a third party has verified the identification of the user; and
c) allowing the user to access the computer through the authentication gateway after the authentication gateway determines the biometric sample provided matches the biometric sample associated with the user by transmitting one or more codes that are unknown to the user from the authentication gateway to the computer.

14. A method of connecting a user to a computer, comprising the acts of:
confirming the identify of a user at an authentication gateway; and
generating one or more access codes that are associated with the user by the computer and are required for the user to access the computer, wherein the one or more codes are generated at an authentication gateway after the identity of the user has been confirmed and wherein the one or more codes are unknown to the user.

15. A method of controlling access to a computer in a computer network comprising the acts of:
receiving a biometric sample from a user at an authentication gateway;
confirming the identity of the user with a third party;
associating the biometric sample with the user after their identity has been confirmed and storing the associated biometric sample at the authentication gateway;
receiving another biometric sample when the user accesses the authentication gateway;
comparing the received biometric sample with the stored biometric sample to confirm the identity of the user;
receiving a request from the user to access the computer, and
transmitting one or more access codes required by the computer to allow the user to access it, wherein the one or more access codes are unknown to the user.

16. The method of claim 15, wherein the one or more access codes are stored in a cookie file at the authentication gateway.

17. The method of claim 15, wherein the act of confirming the identity of the user with a third party comprises the acts of:
depositing a variable amount of money into a bank account of the user; and
prompting the user to indicate how much money was deposited in the account.

18. A method of transmitting one or more key codes to a user, comprising:
accessing an authentication gateway from a communication device associated with a user;
providing the authentication gateway with a biometric sample that is sensed by the communication device;
comparing the received biometric sample with a stored biometric sample known to belong to the user;
confirming the identity of the user if the biometric sample compares favorably;
receiving a request from the communication device to access a computer on which one or more key codes are stored;
generating or retrieving one or more access codes at the authentication gateway that are unknown to the user in order to access the computer and providing the one or more access codes to the computer on which the one or more key codes are stored; and
receiving the one or more key codes from the computer and returning the one or more key codes to the communication device.

19. A computer access system for storing one or more security codes, comprising:
an authentication gateway that is accessed by a user with an access device that supplies a biometric sample to the authentication gateway, the biometric sample being compared with a biometric sample known to come from the user;
a computer on which the one or more security codes are stored, wherein the user accesses the computer through the authentication gateway to request one or more security codes after the user's identity has been confirmed by the authentication gateway, the computer returning the one or more security codes to the user's access device.

20 The computer system of claim 19, wherein:
the authentication gateway produces one or more access codes to allow the user to access the computer after the user's identity has been confirmed by the authentication gateway, wherein the one or more access codes produced are unknown to the user.

21. The computer access system of claim 19, wherein the authentication gateway associates a biometric sample with a user after the identity of the user has been confirmed by a third party.

22. The computer access system of claim 21, wherein the third party is a bank.

23. A computer system including:
an authentication gateway that is accessed by a user by providing one or more codes and a biometric sample, the biometric sample being compared with a reference sample known to come from the user to confirm the identity of the user; and
a computer system for facilitating financial transactions between the user and a seller, the computer system being accessed by the user through the authentication gateway, after the user's identity has been confirmed, to request a funds transfer between an account of the user and an account of the seller.

24. The computer system of claim 23, wherein the authentication gateway produces one or more access codes to allow the user to access the computer system after the user's identity has been confirmed and wherein the one or more codes produced are unknown to the user.

25. A computer system including:
an authentication gateway that verifies the identity of a user and allows the user to access other computers through the authentication gateway;
a computer system accessible by the user through the authentication gateway for providing and/or registering computer programs or digital content for the user, the computer programs or digital content including a code that unlocks the program or digital content and an instruction that requests the code when the program or digital content is selected by the user;
wherein the code is provided to the program or digital content after the authentication gateway has verified the identity of the user.

26. The computer system of claim 25, wherein the authentication gateway validates the identity of the user by receiving a biometric sample and by comparing the biometric sample received from the user with a reference biometric sample known to come from the user.

27. The computer system of claim 26, wherein the authentication gateway creates the reference biometric sample after the identity of the user has been confirmed by a third party.

28. The computer system of claim 27, wherein the third party is a bank.

29. A computer system for allowing a user to connect to a remote computer system, comprising:
an authentication gateway that is accessed by the user by providing a biometric sample, wherein the authentication gateway compares the biometric sample received with a sample previously known to come from the user to confirm the identity of the user, the authentication gateway transmitting a code stored in a file associated with the user but is unknown to the user in order to allow the user to access the remote computer system.
